(19) United States
(12) Patent Application Publication
(10) Pub. No.: US 2016/0056537 A1
(43) Pub. Date: Feb. 25, 2016

(54) SYSTEMS AND METHODS FOR A STEERED BEAM HORN ANTENNA

(71) Applicant: Honeywell International Inc., Morristown, NJ (US)

(72) Inventors: Michael G. Guler, Dawsonville, GA (US); William Pratt Mounfield, JR., Lexington, SC (US)

(21) Appl. No.: 14/538,342

(22) Filed: Nov. 11, 2014

Related U.S. Application Data
(60) Provisional application No. 62/039,163, filed on Aug. 19, 2014.

(51) Int. Cl. H01Q 3/02; H01Q 13/02

(52) U.S. Cl. CPC H01Q 3/02; H01Q 13/02

(57) ABSTRACT

Systems and methods for a steered beam horn antenna are provided. In one embodiment, a steered beam horn antenna system comprises: a steerable horn antenna comprising: an adjustable flare component; and a waveguide component having a rear port that opens to a waveguide interface and a frontal port that opens to the adjustable flare component. The adjustable flare component includes: a first outer horn plate configured to rotate about a first pivot line; and a second outer horn plate configured to rotate about a second pivot line. The system further comprises at least one actuator and a controller that operates the actuator to position the first and second outer horn plates into asymmetrical positions with respect to a boresight axis of the steerable horn antenna in response to an input command.

### CROSS-REFERENCE TO RELATED APPLICATION

This application is a non-provisional application claiming priority to, and the benefit of, U.S. Provisional Patent Application No. 62/039,163, entitled “STEERED BEAM HORN ANTENNA”, Attorney Docket No. H0046951, filed on Aug. 19, 2014, which is incorporated herein by reference in its entirety.

### BACKGROUND

Horn antennas are a type of electromagnetic waveguide used to direct electromagnetic energy in a specific direction. This ability to direct electromagnetic energy, as opposed to an omnidirectional transmission of the energy, greatly reduces the required active amplification needed for establishing a specific link because power is focused to form a beam. However, in the current state of the art, redirecting the beam requires the horn antenna to be mounted onto a positioning system which can rotate the horn antenna to vary its working direction. The most common positioning system in the art today rotates the entire horn antenna assembly about one or more axes to vary the working direction. Typically the radio electronics (that is, the receiver and/or transmitter) coupled to the horn antenna remains fixed while the antenna is rotated into position. This configuration forcing the need for flexible cables or rotary joints to pass signals between the moving antenna and the radio electronics. These elements that facilitate the coupling between the radio electronics and the horn antenna are often a source of signal loss, unwanted noise, and system failure mechanisms.

For the reasons stated above and for other reasons stated below which will become apparent to those skilled in the art upon reading and understanding the specification, there is a need in the art for alternate systems and methods for providing a steered beam horn antenna.

### SUMMARY

The Embodiments of the present invention provide methods and systems for providing a steered beam horn antenna and will be understood by reading and studying the following specification.

Systems and methods for a steered beam horn antenna are provided. In one embodiment, a steered beam horn antenna system comprises: a steerable horn antenna comprising: an adjustable flare component; and a waveguide component having a rear port that opens to a waveguide interface and a frontal port that opens to the adjustable flare component. The adjustable flare component includes: a first outer horn plate movably coupled to a first wall of the frontal port and configured to rotate about a first pivot line; and a second outer horn plate movably coupled to a second wall of the frontal port opposite to the first wall and configured to rotate about a second pivot line. The system further includes at least one actuator coupled to the first outer horn panel and the second outer horn panel; and a controller coupled to the at least one actuator, wherein the controller operates the at least one actuator to position the first outer horn plate and the second outer horn plate into asymmetrical positions with respect to a boresight axis of the steerable horn antenna in response to an input command.

### DRAWINGS

Embodiments of the present invention can be more easily understood and further advantages and uses thereof more readily apparent, when considered in view of the description of the preferred embodiments and the following figures in which:

FIG. 1 is a diagram illustrating a steered horn antenna system of one embodiment of the present disclosure;

FIG. 2 is a diagram illustrating operation of a steered horn antenna of one embodiment of the present disclosure;

FIGS. 3 and 3B are diagrams illustrating a steered horn antenna of another embodiment of the present disclosure; and

FIG. 4 is a flow chart illustrating a method for steering a horn antenna of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure provide systems and methods for a steered beam horn antenna that utilizes movable outer horn plates that are asymmetrically rotated about pivot lines defined at the frontal port of a waveguide component. The radio electronics coupled to the horn antenna are connected via a backside (or rear) port of the waveguide component, eliminating the need for flexible cables or rotary joints. For example, in an E-plane Sectorial horn antenna, the horn flairs in the direction of the E-field. With embodiments of the present disclosure, steering of electromagnetic energy is accomplished by mechanically pivoting the outer horn plates asymmetrically with respect to the bore sight axis of the waveguide component. The asymmetrical alignment of the outer horn plates results in an antenna gain pattern (e.g. a radiation pattern) having a main lobe offset in the E-plane from a bore sight axis of the waveguide component. In different implementations, mechanical rotation of the outer horn plates can be accomplished by various alternative motorized systems. Further, the outer horn plates can be hinged at their respective pivot lines and moved with push rods. In alternative embodiments, the outer horn plates may be interconnected such that they move in unison, or they may have independent rotational control. Independent control of the two outer horn plates allows for beam steering as well as beam width control.

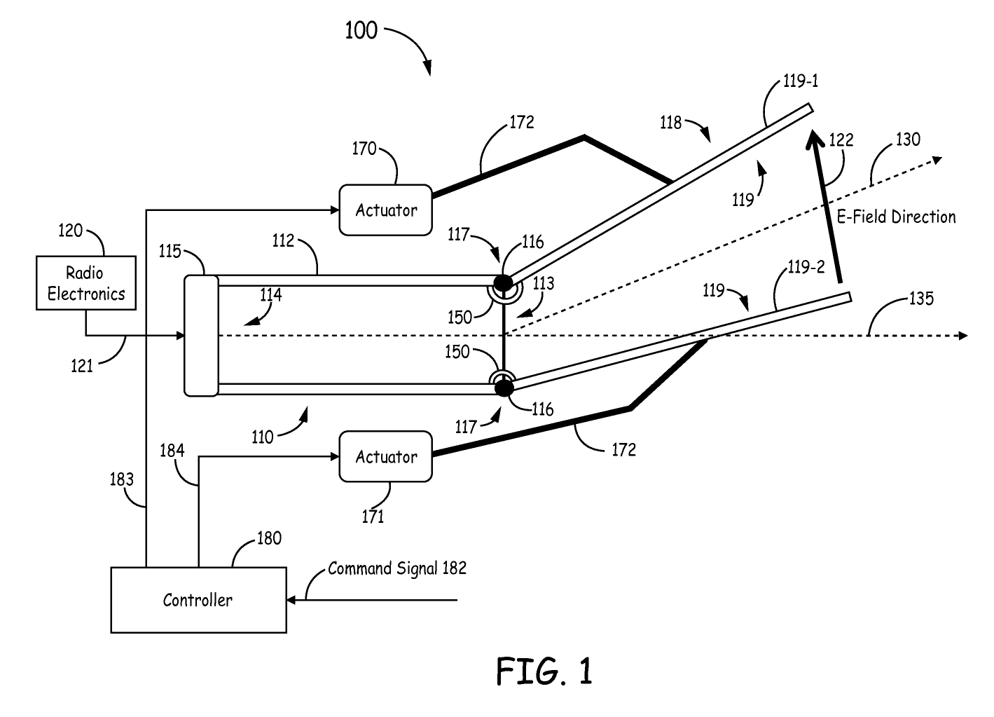

FIG. 1 is a diagram of a steered beam horn antenna system 100 of one embodiment of the present disclosure. In the system 100 shown in FIG. 1, one or more components of radio electronics 120 are coupled to a steerable horn antenna 110. Radio electronics 120 may comprise for example, one or more radio transmitters, receivers, signal conditioners or processors, or any combination thereof. Steerable horn antenna 110 comprises a waveguide component 112 and adjustable flare component 118. In one embodiment, the waveguide component 112 is a parallel wall waveguide having a frontal port 113 (which leads to the adjustable flare assembly 118) and a rear port 114. The rear port 114 opens to a waveguide interface 115 which is coupled to the radio electronics 120 via a cable, co-axial waveguide adapter, or similar device 121 for carrying electromagnetic energy between the waveguide component 112 and the radio electronics 120. The waveguide interface may accommodate a single antenna feed into the waveguide component 112, or multiple feeds (as further described below). The adjustable flare assembly 118 includes first and second outer horn plates 119 (referred to individually as 119-1 and 119-2 respectively) which are movably coupled to opposite walls of the frontal port 113 of the waveguide component 112 along pivot lines 117. As shown in FIG. 1, the outer horn plates 119 are coupled to the opposing sides of the waveguide component 112 that define the direction of the E-field vector 122 for electromagnetic energy flowing through the steerable horn antenna 110. As such, in one embodiment, the pivot lines 117 each define an axis orthogonal to the E-field vector 122 so that the outer horn plates 119 rotate in a direction along the E-field vector 122. Although not necessary to practice embodiments of the present disclosure, in other embodiments, adjustable flare assembly 118 may optionally include one or more internal horn plates (i.e., located between outer horn plate 119-1 and 119-2) which may be either fixed in position or themselves movable.

The outer horn plates 119 as well as the waveguide component 112 are comprised of a material that is an electrically conductive material. Such a material may include, for example, Aluminum or Copper. In some embodiments, all or part of these elements be fabricated from a composite material, such as a material that incorporates an electrically conductive mesh. Where a composite or mesh material is utilized, the outer horn plates 119 may form a continuous piece with the waveguide component 112 where the material is thinned or otherwise configured to be flexible along the pivot lines 117 so that the outer horn plates 119 may move. In other embodiment, bearings, hinges, or other similar mechanical coupling component 116 may be used to mechanically couple the outer horn plates 119 to the waveguide component 112 along the pivot lines 117.

In one embodiment in operation, in the case of a transmitted signal for example, electromagnetic energy is generated by radio electronics 120 and supplied to the steerable horn antenna 110 at rear port 114 via waveguide interface 115 and travels through waveguide component 112 towards frontal port 113. The electromagnetic energy emerges from the frontal port 113 and bends to follow the waveguide path established by the outer horn plates 119. A main lobe of the transmitted electromagnetic energy will emerge from the steerable horn antenna 110 along a vector 130 that is perpendicular to the E-field vector 122 and offset from the boresight axis 135 of the waveguide component 112. That is, if the outer horn plates 119 were rotated into positions that were symmetrical with respect to the frontal port 122, a main lobe would be expected to form along an axis 135 that exits the waveguide component 112 normal to the plane of the frontal port 122. This axis is referred to herein as the boresight axis 135 of the steerable horn antenna 110. With embodiments of the present disclosure, the main lobe emerges in the direction of vector 130, which is offset in the E-plane with respect to the boresight axis 135. The angle of offset between vector 130 and the boresight axis 135 is a function of the asymmetrical relative positioning of the outer horn plates 119. Similarly, in the case of a received signal, the main lobe of the antenna gain patterns will be offset from the boresight axis 135 by an angle that is a function of the asymmetrical relative positioning of the outer horn plates 119.

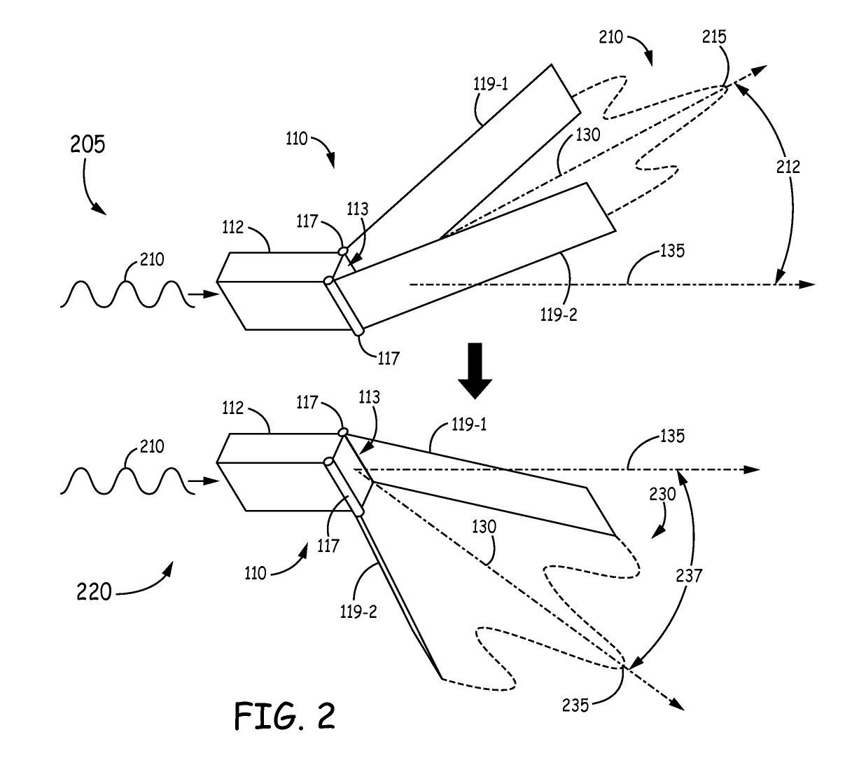

The steering of the main lobe to a desired direction through the asymmetrical relative positioning of the outer horn plates 119 is illustrated in FIG. 2. As shown in FIG. 2, electromagnetic energy 210 enters into the waveguide component 112 and travels towards frontal port 113. With outer horn plates 119 asymmetrically rotated to a first position (shown at 205) towards one side of boresight axis 135, the main lobe 215 of an antenna radiation pattern 210 emerges at a first angle 212 that is offset from the boresight axis 135 of steerable horn antenna 110. Then when the outer horn plates 119 are mechanically rotated about their respective pivot lines 117 to the second position (shown at 220) toward the opposite side of boresight axis 135, a different radiation pattern 230 emerges having a main lobe 235 offset from the boresight axis 135 of steerable horn antenna 110 by a second angle 237. In this manner, through the relative positioning of outer horn plates 119, steerable horn antenna 110 may be dynamically reconfigured to steer the electromagnetic energy 210, for example, to aim the electromagnetic energy 210 at the location of different targets, or to dynamically follow a moving target.

Referring back to FIG. 1, in some embodiments, in order to maintain consistent electrical continuity between the outer horn plates 119 and the waveguide component 112, one or more electrical coupling devices 150 may be utilized. In some embodiments, electrical coupling devices 150 may comprise metallic fingers, such as Beryllium Copper fingers, that are affixed to the waveguide component 112 and say in contact with their respective outer horn plate 119 during rotation. In other embodiments, such as for high frequency applications (which would be the case for most applications that utilize horn antennas) the more electrical coupling devices 150 may establish a capacitive coupling between the respective outer horn plates 119 and the waveguide component 112. Is should be appreciated that at lower frequencies, a higher capacitance is needed to form a capacitive coupling than when transmitting higher frequency electromagnetic energy. In still other embodiments, such as where both the outer horn plates 119 and the waveguide component 112 are formed from a continuous conductive mesh material, the function of the electrical coupling devices 150 may be achieved by the material itself.

As indicated in FIG. 1, pivoting of the outer horn plates 119 about their respective pivot lines 117 may be achieved through the use of one or more actuators (shown by 170 and 171) coupled to the outer horn plates 119 via one or more linkages. For example, in the system 100 shown in FIG. 1, a 4-bar linkage (shown by 172) is utilized to couple each of the outer horn plates 119-1 and 119-2 to their respective actuators 170, 171. However, in other implementations, other linkage configurations may be utilized. For example, in some embodiments, both outer horn plates 119-1 and 119-2 may be linked to a common actuator and mechanically operated together rather than independently. Further, for some implementations, a direct drive configuration may be utilized, for example, through an actuator directly applying torque to rotate the outer horn plates 119 at their principle rotation axis (i.e., pivot lines 117). In one embodiment, the actuators 170, 171 may each comprise an electro-mechanical device such as an electric motor. For example, in one embodiment, the actuators 170, 171 each comprise a brushless DC motor having a 50:1 planetary gear set drive. In other implementation, actuators 170, 171 may instead provide the mechanical force to pivot outer horn plates 119 by other means, such as through hydraulics or pneumatics.

In one embodiment, steered beam horn antenna system 100 further comprises a controller 180 that converts incoming command signals 182 into positioning signals 183 and 184 that drive the actuators 170 and 171. The positioning signals 183 and 184 are generated by controller 180 to coordinate rotation and positioning of the respective outer horn plates 119-1 and 119-2. For example, in one embodiment, an input command signal 182 to controller 180 specifies a desired direction to which the main lobe of an electromagnetic energy beam should be steered. Controller 180 converts that command signal 182 to a first positioning signal 183 to operate actuator 170 to pivot outer horn plate 119-1 into position. Controller 180 also converts the command signal 182 to a second positioning signal 184 to actuator 171 to pivot outer horn plate 119-2 into position. Outer horn plate 119-1 is positioned using positioning signal 183, and horn plate 119-2 is positioned using positioning signal 184 thusly to steer the adjustable flare component 118 as directed by the command signal 182. In one embodiment, the command signal 182 provides dynamic input commands such that the steered beam horn antenna system 100 can continuously steer electromagnetic energy to track a moving target.

It should also be appreciated that positioning can also serve to open and close the horn antenna aperture (i.e., the angle between the first and second outer horn plates 119-1 and 119-2) so that beam shaping may be accomplished in addition to beam steering. Accordingly, in some embodiments, the input command signal 182 may be accompanied by another parameter that provides an indication for a desired beam width. For example, the desired beam width may be indicated by directly specifying an angle between the first outer horn plate 119-1 and the second outer horn plate 119-2. In other embodiments, it may instead be indicated by specifying a different parameter which is then converted into an angle between the horn plates 119-1 and 119-2 by controller 180. Positioning the outer horn plates 119 to form a smaller aperture will broaden the radiation pattern (increasing the antenna's angular field of view, for example) while positioning the outer horn plates 119 to form a relatively larger aperture will narrow the radiation pattern (increasing the effective operating distance of the antenna). Such an implementation may be useful, for example, in an application where a wider radiation pattern is initially used to locate a desired target, and after acquisition, a narrower radiation pattern is steered as described herein to maintain contact with the target at a higher power level.

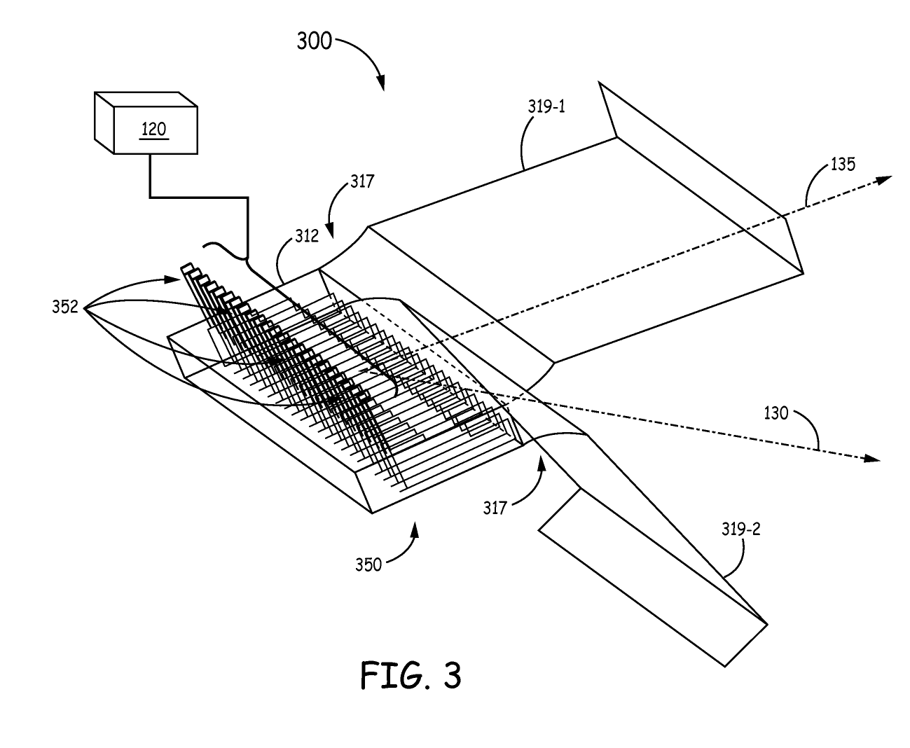

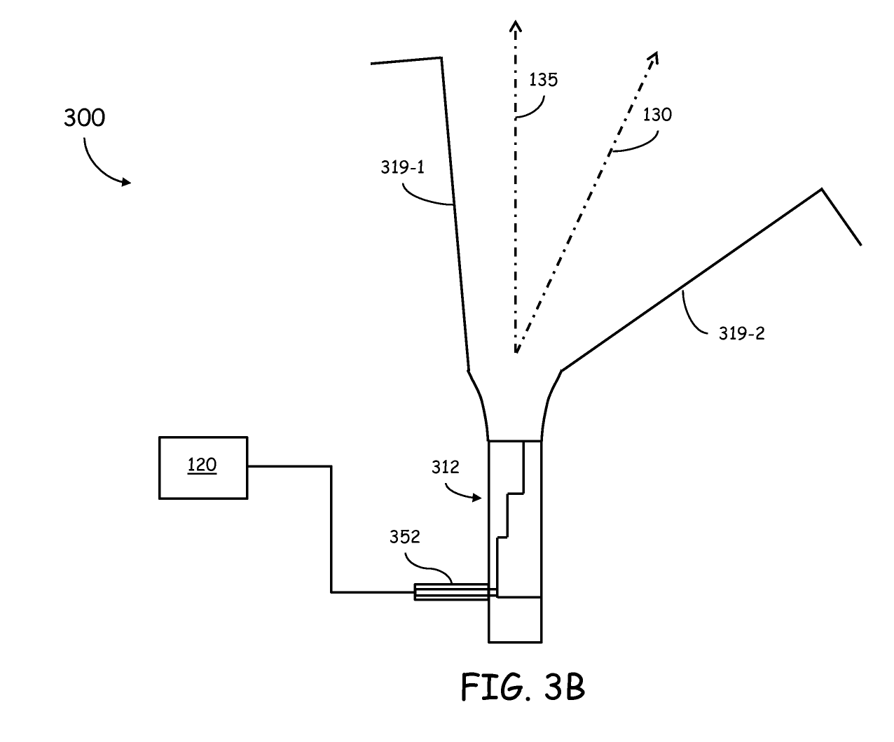

In still other embodiments, the steerable horn antenna 110 can be extended or arrayed in a direction orthogonal to that of the mechanical beam steering provided by rotating the horn plates 119. Such an embodiment provides for a main lobe having still higher gains and allows for electronic steering in this orthogonal direction, providing two degrees of freedom for performing beam steering. One such embodiment is shown by the steerable horn antenna 300 shown in FIGS. 3 and 3B. Steerable horn antenna 300 includes first and second outer horn plates 319-1 and 319-2 coupled to a waveguide component 312 in a pilotable configuration about their respective pivot lines 317 in the same manner as described with respect to any of the embodiments illustrated by FIGS. 1 and 2 or otherwise described above. That is, any of the configurations, features or elements described with respect to FIG. 1 or 2 may be similarly applied to steerable horn antenna 300 and vice versa. In one embodiment, the steerable horn antenna 100 described above is implemented using steerable horn antenna 300.

In FIGS. 3 and 3B, the steerable horn antenna 300 includes an electronic array 350 which extends in a second direction approximately orthogonal to the first direction of the mechanical beam steering accomplished by rotating the outer horn plates 319-1 and 319-2 about their respective pivot lines 317. That is, the electronic array 350 provides for further steering of the main lobe in a second direction having a component orthogonal to the first direction (that is, orthogonal to the plane defined by the vector 130 and the boresight axis 135). The electronic array 350 includes multiple individual feed points 352 for transferring electromagnetic energy into the steerable horn antenna 300. The electronic array 350 is coupled, for example, to the radio electronics 120. In one embodiment, the individual feed points 352 comprise stepped veins to provide for impedance matching of the signal from the individual feed points 352 in into waveguide component 312. Further, each of the individual feed points 352 may be independently driven by radio electronics 120 and the phase relationship between each controlled. By controlling these phase relationships, electronic array 350 may be electronically tailored to affect beam steering in the second direction. Thus, through the use of the electronic beam steering and the mechanical rotation of the plates 319-1 and 319-2, the steerable horn antenna 300 provides a 2-dimensional steered system.

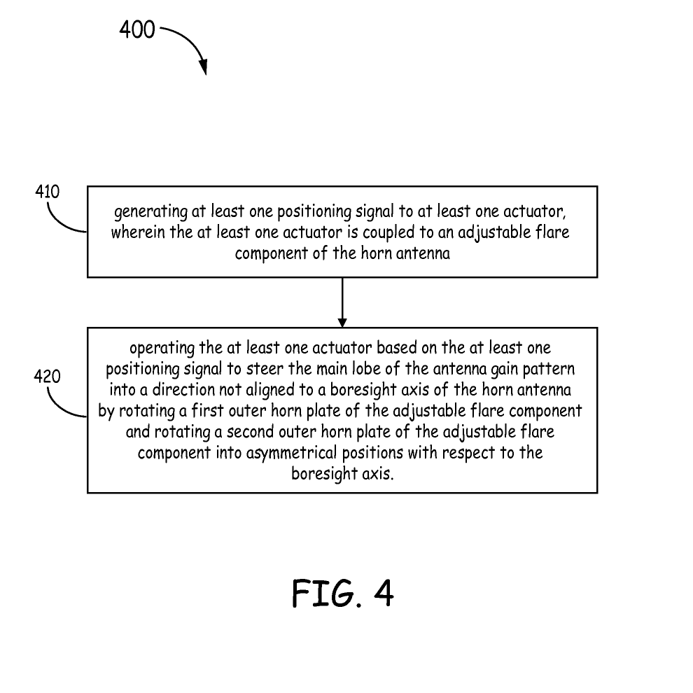

FIG. 4 is flow chart depicting a method 400 of steering an RF beam using a horn antenna of one embodiment of the present disclosure. Method 400 can be implemented through the use of a steered horn antenna, such as any of those described above. The method begins at 410 with generating at least one positioning signal to at least one actuator, wherein the at least one actuator is coupled to an adjustable flare component of the horn antenna. In one embodiment, in addition to the adjustable flare component, the horn antenna further comprises a waveguide component having a rear port that opens to a waveguide interface and a frontal port that opens to the adjustable flare component. The first outer horn plate is movably coupled to a first wall of the frontal port and configured to rotate about a first pivot line and the second outer horn plate is movably coupled to a second wall of the frontal port opposite to the first wall and configured to rotate about a second pivot line. As described with respect to FIGS. 1-3 above, using at least one radio electronics component coupled to the waveguide interface, an electromagnetic energy signal may be transmitted into the waveguide component while operating the at least one actuator to steer the main lobe of the antenna gain pattern.

The method proceeds to 420 with operating the at least one actuator based on the at least one positioning signal to steer the main lobe of the antenna gain pattern into a direction not aligned to a boresight axis of the horn antenna by rotating the first outer horn plate of the adjustable flare component and rotating the second outer horn plate of the adjustable flare component into asymmetrical positions with respect to the boresight axis.

The at least one positioning signal may be generated using a controller coupled to the at least one actuator (such as, for example, controller 180 discussed above). The controller operates the at least one actuator to position the first outer horn plate and the second outer horn plate into asymmetrical positions with respect to a boresight axis of the steerable horn antenna in response to an input command. The first and second outer horn plates are positioned to direct the electromagnetic energy signal in a direction offset from the boresight axis of the steerable horn antenna by an angle determined from the input command. In one embodiment, the input command may include a first parameter indicating a direction to which the electromagnetic energy beam should be steered as well as a second parameter that indicates how to adjust the horn antenna aperture of the horn antenna. In one embodiment, the horn antenna may further include multiple feed points to provide electronic steering of main lobe in addition to the mechanical steering, such as described above with respect to FIG. 3 and steered horn antenna 300. That is, while mechanical steering (i.e., asymmetrical pivoting of the outer horn plates) is used to move the main lobe along a first axis, electronic steering (i.e., by adjusting the phase relationship of the multiple feed points) is used to move the main lobe along a second axis.

### Example Embodiments

Example 1 includes a steered beam horn antenna system, the system comprising: a steerable horn antenna comprising: an adjustable flare component; and a waveguide component having a rear port that opens to a waveguide interface and a frontal port that opens to the adjustable flare component; wherein the adjustable flare component includes: a first outer horn plate movably coupled to a first wall of the frontal port and configured to rotate about a first pivot line; and a second outer horn plate movably coupled to a second wall of the frontal port opposite to the first wall and configured to rotate about a second pivot line; at least one actuator coupled to the first outer horn panel and the second outer horn panel; and a controller coupled to the at least one actuator, wherein the controller operates the at least one actuator to position the first outer horn plate and the second outer horn plate into asymmetrical positions with respect to a boresight axis of the steerable horn antenna in response to an input command.

Example 2 includes the system of example 1, further comprising: at least one radio electronics component coupled to the waveguide interface generating electromagnetic energy into the steerable horn antenna.

Example 3 includes the system of example 2, wherein the first outer horn plate and the second outer horn plate direct the electromagnetic energy to emerge from the steerable horn antenna with a main lobe having a direction offset from the boresight axis of the steerable horn antenna by an angle determine from the input command.

Example 4 includes the system of any of examples 2-3, wherein the waveguide interface comprises multiple feed points for feeding into the waveguide component the electromagnetic energy from the at least one radio electronic radio component.

Example 5 includes the system of example 4, wherein the multiple feed points define an electronic phased array; wherein the first outer horn plate and the second outer horn plate direct the electromagnetic energy to emerge from the steerable horn antenna with a main lobe having a first direction offset from the boresight axis of the steerable horn antenna by an angle determined from the input command; and the multiple feed points are configured to electronically steer the main lobe in a second direction offset from the boresight axis, the second direction having a component orthogonal to the first direction.

Example 6 includes the system of any of examples 1-5, wherein one or both of first outer horn plate and the second outer horn plate are coupled to the frontal port of the waveguide component by at least one hinge.

Example 7 includes the system of any of examples 1-6, wherein one or both of the first outer horn plate and the second outer horn plate are each coupled to the waveguide component by a flexible electrically conductive material.

Example 8 includes the system of any of examples 1-7, further comprising: a first electrical coupling device that electrically couples the first outer horn plate to the waveguide component; and a second electrical coupling device that electrically couples the second outer horn plate to the waveguide component.

Example 9 includes the system of example 8, wherein one or both of the first electrical coupling device and the second electrical coupling device comprise Beryllium Copper fingers.

Example 10 includes the system of any of examples 1-9, wherein the controller is configured to steer an operating direction of the steerable horn antenna and adjust a horn antenna aperture of the steerable horn antenna based on parameters communicated by the input command.

Example 11 includes a method for steering a horn antenna, the antenna having an antenna gain pattern that includes a main lobe, the method comprising: generating at least one positioning signal to at least one actuator, wherein the at least one actuator is coupled to an adjustable flare component of the horn antenna; and operating the at least one actuator based on the at least one positioning signal to steer the main lobe of the antenna gain pattern into a direction not aligned to a boresight axis of the horn antenna by rotating a first outer horn plate of the adjustable flare component and rotating a second outer horn plate of the adjustable flare component into asymmetrical positions with respect to the boresight axis.

Example 12 includes the method of example 11, further comprising: generating the at least one positioning signal using a controller coupled to the at least one actuator, wherein the controller operates the at least one actuator to position the first outer horn plate and the second outer horn plate into asymmetrical positions with respect to a boresight axis of the steerable horn antenna in response to an input command.

Example 13 includes the method of any of examples 12, further comprising: positioning the first outer horn plate and the second outer horn plate to direct the electromagnetic energy signal in a direction offset from the boresight axis of the steerable horn antenna by an angle determined from the input command.

Example 14 includes the method of any of examples 12-13, wherein operating the at least one actuator further comprises: adjusting an operating direction of the horn antenna and adjust a horn antenna aperture of the horn antenna based on parameters communicated by the input command.

Example 15 includes the method of any of examples 11-14, wherein the horn antenna comprises: the adjustable flare component; and a waveguide component having a rear port that opens to a waveguide interface and a frontal port that opens to the adjustable flare component; wherein the first outer horn plate is movably coupled to a first wall of the frontal port and configured to rotate about a first pivot line; and wherein the second outer horn plate is movably coupled to a second wall of the frontal port opposite to the first wall and configured to rotate about a second pivot line.

Example 16 includes the method of example 15, the method further comprising: using at least one radio electronics component coupled to the waveguide interface, transmitting an electromagnetic energy signal into the waveguide component while operating the at least one actuator to steer the main lobe of the antenna gain pattern.

Example 17 includes the method of any of examples 15-16, wherein one or both of first outer horn plate and the second outer horn plate are coupled to the frontal port of the waveguide component by at least one hinge.

Example 18 includes the method of any of examples 15-17, wherein one or both of the first outer horn plate and the second outer horn plate are each coupled to the waveguide component by a flexible electrically conductive material.

Example 19 includes the method of any of examples 11-18, wherein the horn antenna comprises: the adjustable flare component; and a waveguide component having a rear port that opens to a waveguide interface and a frontal port that opens to the adjustable flare component; wherein the waveguide interface comprises multiple feed points for feeding into the waveguide component electromagnetic energy from at least one radio electronic radio component.

Example 20 includes the method of example 19, wherein the multiple feed points define an electronic phased array, the method further comprising: adjusting a phase relationship between the multiple feed points to further steer the main lobe in a second direction.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A steered beam horn antenna system, the system comprising:
a steerable horn antenna comprising:
an adjustable flare component; and
a waveguide component having a rear port that opens to a waveguide interface and a frontal port that opens to the adjustable flare component;
wherein the adjustable flare component includes:
a first outer horn plate movably coupled to a first wall of the frontal port and configured to rotate about a first pivot line; and
a second outer horn plate movably coupled to a second wall of the frontal port opposite to the first wall and configured to rotate about a second pivot line;
at least one actuator coupled to the first outer horn panel and the second outer horn panel; and
a controller coupled to the at least one actuator, wherein the controller operates the at least one actuator to position the first outer horn plate and the second outer horn plate into asymmetrical positions with respect to a boresight axis of the steerable horn antenna in response to an input command.

2. The system of claim 1, further comprising:
at least one radio electronics component coupled to the waveguide interface generating electromagnetic energy into the steerable horn antenna.

3. The system of claim 2, wherein the first outer horn plate and the second outer horn plate direct the electromagnetic energy to emerge from the steerable horn antenna with a main lobe having a direction offset from the boresight axis of the steerable horn antenna by an angle determine from the input command.

4. The system of claim 2, wherein the waveguide interface comprises multiple feed points for feeding into the waveguide component the electromagnetic energy from the at least one radio electronic radio component.

5. The system of claim 4, wherein the multiple feed points define an electronic phased array;
wherein the first outer horn plate and the second outer horn plate direct the electromagnetic energy to emerge from the steerable horn antenna with a main lobe having a first direction offset from the boresight axis of the steerable horn antenna by an angle determined from the input command; and
the multiple feed points are configured to electronically steer the main lobe in a second direction offset from the boresight axis, the second direction having a component orthogonal to the first direction.

6. The system of claim 1, wherein one or both of first outer horn plate and the second outer horn plate are coupled to the frontal port of the waveguide component by at least one hinge.

7. The system of claim 1, wherein one or both of the first outer horn plate and the second outer horn plate are each coupled to the waveguide component by a flexible electrically conductive material.

8. The system of claim 1, further comprising:
a first electrical coupling device that electrically couples the first outer horn plate to the waveguide component; and
a second electrical coupling device that electrically couples the second outer horn plate to the waveguide component.

9. The system of claim 8, wherein one or both of the first electrical coupling device and the second electrical coupling device comprise Beryllium Copper fingers.

10. The system of claim 1, wherein the controller is configured to steer an operating direction of the steerable horn antenna and adjust a horn antenna aperture of the steerable horn antenna based on parameters communicated by the input command.

11. A method for steering a horn antenna, the antenna having an antenna gain pattern that includes a main lobe, the method comprising:
generating at least one positioning signal to at least one actuator, wherein the at least one actuator is coupled to an adjustable flare component of the horn antenna; and
operating the at least one actuator based on the at least one positioning signal to steer the main lobe of the antenna gain pattern into a direction not aligned to a boresight axis of the horn antenna by rotating a first outer horn plate of the adjustable flare component and rotating a second outer horn plate of the adjustable flare component into asymmetrical positions with respect to the boresight axis.

12. The method of claim 11, further comprising:
generating the at least one positioning signal using a controller coupled to the at least one actuator, wherein the controller operates the at least one actuator to position the first outer horn plate and the second outer horn plate into asymmetrical positions with respect to a boresight axis of the steerable horn antenna in response to an input command.

13. The method of claim 12, further comprising:
positioning the first outer horn plate and the second outer horn plate to direct the electromagnetic energy signal in a direction offset from the boresight axis of the steerable horn antenna by an angle determined from the input command.

14. The method of claim 12, wherein operating the at least one actuator further comprises:
adjusting an operating direction of the horn antenna and adjust a horn antenna aperture of the horn antenna based on parameters communicated by the input command.

15. The method of claim 11, wherein the horn antenna comprises:
the adjustable flare component; and
a waveguide component having a rear port that opens to a waveguide interface and a frontal port that opens to the adjustable flare component;
wherein the first outer horn plate is movably coupled to a first wall of the frontal port and configured to rotate about a first pivot line; and
wherein the second outer horn plate is movably coupled to a second wall of the frontal port opposite to the first wall and configured to rotate about a second pivot line.

16. The method of claim 15, the method further comprising:
using at least one radio electronics component coupled to the waveguide interface, transmitting an electromagnetic energy signal into the waveguide component while operating the at least one actuator to steer the main lobe of the antenna gain pattern.

17. The method of claim 15, wherein one or both of first outer horn plate and the second outer horn plate are coupled to the frontal port of the waveguide component by at least one hinge.

18. The method of claim 15, wherein one or both of the first outer horn plate and the second outer horn plate are each coupled to the waveguide component by a flexible electrically conductive material.

19. The method of claim 11, wherein the horn antenna comprises:
the adjustable flare component; and
a waveguide component having a rear port that opens to a waveguide interface and a frontal port that opens to the adjustable flare component;
wherein the waveguide interface comprises multiple feed points for feeding into the waveguide component electromagnetic energy from at least one radio electronic radio component.

20. The method of claim 19, wherein the multiple feed points define an electronic phased array, the method further comprising:
adjusting a phase relationship between the multiple feed points to further steer the main lobe in a second direction.
